(19) United States
(12) Patent Application Publication
(10) Pub. No.: US 2005/0147212 A1
(43) Pub. Date: Jul. 7, 2005

(54) Network support for customized automatic call answering and holding

(75) Inventors: David S. Benco, Winfield, IL (US); Kevin J. Overend, Elmhurst, IL (US); Baoling S. Sheen, Naperville, IL (US); Sandra Lynn True, St. Charles, IL (US); Kenneth J. Voight, Sugar Grove, IL (US)

Correspondence Address: Richard J. Minnich, Esq.;Fay, Sharpe, Fagan, Minnich & McKee, LLP, Seventh Floor, 1100 Superior Avenue, Cleveland, OH, 44114-2518, US

(73) Assignee: Lucent Technologies Inc.

(21) Appl. No.: 10/751,374

(22) Filed: Jan. 5, 2004

(51) Int. Cl. H04M 1/64; H04M 11/00

(52) U.S. Cl. 379/84; 379/215.01; 379/201.01

(57) ABSTRACT

A communications network answers a call directed to user equipment that is already engaged in a call. A call holding indication is transmitted to the user equipment of the subscriber. The subscriber may indicate a call treatment preference. A default or customized message may be transmitted to the second caller. Caller identification information and/or a subscriber response may be used to select the message. If the second caller elects to be placed on hold, the second call is placed on hold. The call holding indication may be transmitted before or after the call is placed on hold. The subscriber may use information included in the call holding indication in determining the call treatment preference. For example, a parent may select a custom message, based on caller identification information received in the call holding indication, asking a child of the parent to wait while the first call is completed.

### BACKGROUND

The present disclosure is related to the art of call processing. More specifically, the disclosure is directed to methods and systems for processing an incoming call leg directed to user equipment of a communications services subscriber when the user equipment of the subscriber is already engaged in a call. Embodiments will be described with reference to mobile or cellular communications systems. However, embodiments can be readily adapted to wireline and other communications services networks.

A variety of call treatment options are available to communications services subscribers. For example, for an added service charge, subscribers can subscribe to voice mail, call waiting, call forwarding and/or calling line identification (caller ID) services. However, these services do not adequately address the needs or desires of at least some communication services subscribers.

Voicemail allows a caller to leave a message for a subscriber when the user equipment of the subscriber is engaged in another call (is busy), does not answer call and/or has the user equipment turned off. However, in some instances, the calling party wants to be sure that the subscriber receives the caller's message or may need an immediate response. Therefore, leaving a voicemail message may leave the calling party dissatisfied. Additionally, when the subscriber receives the voicemail message, the subscriber may return a call to the calling party at a time when the original calling party is no longer available. Under some circumstances, the subscriber may be able to leave a message for the original calling party in an attempt to complete the desired communication. However, the subscriber may need more information from the original calling party in order to fully respond. In such circumstances, the original calling party may be required to make yet another call.

Where the subscriber subscribes to a call waiting feature, the original calling party may have a better chance of satisfying their need for immediate communication. For example, if the subscriber is using the user equipment of the subscriber in a first call when the calling party places a call directed at that user equipment, the subscriber will receive a signal indicating that someone is attempting to establish communications with the subscriber. The subscriber may opt to answer the second call. However, answering the second call requires the subscriber to interrupt the current call. This can be annoying to both the subscriber and to the first party, whose communication with the subscriber is being interrupted. Furthermore, the subscriber may opt not to answer the second call, again frustrating the caller's attempt at immediate communication.

Call forwarding transfers a call that goes unanswered at a first set of user equipment to a second and/or third set of user equipment, in search of the subscriber. Call forwarding can satisfy the calling parties need for immediate communication when the subscriber is not engaged in another call. However, call forwarding is of little assistance when the subscriber is engaged in another call.

For the foregoing reasons, there is a desire for a call treatment method that provides more immediate communication between a calling party and a busy subscriber and minimizes interruptions to communications of the subscriber.

### SUMMARY OF THE INVENTION

A method for processing a second call leg directed to a subscriber that is participating in a first call includes receiving the second call leg directed to the subscriber, determining that the subscriber subscribes to a call answering and holding feature, determining whether the subscriber desires to place the second call leg on hold, transmitting a message to a calling party associated with the second call leg offering to place the second call leg on hold if the subscriber desires to place the second call leg on hold, receiving an indication that the calling party accepts the offer to be placed on hold if the message to the calling party is transmitted, placing the second call leg on hold if the indication that the calling party accepts the offer is received and indicating to the subscriber that the second call leg is available, if at the time of indication, the second call leg is available.

Indicating to the subscriber that the second call leg is available can occur before transmitting the message to the calling party associated with the second call leg.

In some instances, determining whether the subscriber desires to place the second call leg on hold includes receiving an indication that the subscriber does not desire that the second call leg be placed on hold, therefore, not transmitting the message to the calling party associated with the second call leg offering to place the second call leg on hold.

Sometimes, determining whether the subscriber desires to place the second call leg on hold can include receiving a message selection indication from the subscriber, thereby receiving an indication that the subscriber does desire that the second call leg be placed on hold. In some of these cases transmitting the message to the calling party associated with the second call leg includes transmitting a customized message to the calling party based on the received message selection indication.

In some embodiments determining whether the subscriber desires to place the second call leg on hold can include receiving a message selection indication from the subscriber, thereby receiving an indication that the subscriber does desire that the second call leg be placed on hold and determining an identity of the calling party. In some of these embodiments transmitting the message to the calling party associated with the second call leg can include transmitting a customized message to the calling party based on the received message selection indication and the determined identity of the calling party.

In some instances determining whether the subscriber desires to place the second call leg on hold includes determining the identity of the calling party, transmitting the determined identity of the calling party to the subscriber, receiving a message selection indication from the subscriber, thereby receiving an indication that the subscriber does desire that the second call leg be placed on hold. Under these circumstances transmitting the message to the calling party associated with the second call leg can include transmitting a customized message to the calling party based on the received message selection indication and the determined identity of the calling party.

In some embodiments determining whether the subscriber desires to place the second call leg on hold includes receiving information from a subscriber profile of the subscriber indicating that the subscriber desires to place on hold all second calls received while the subscriber is participating in any other call.

Sometimes determining whether the subscriber desires to place the second call leg on hold includes receiving information from a subscriber profile of the subscriber indicating that the subscriber desires to place on hold only second calls associated with potential callers included in a predefined list of potential callers, determining an identity associated with a caller associated with the second call leg and determining if the identity associated with the caller is included in the predefined list of potential callers, thereby determining whether the subscriber desires to place the second call leg on hold comprises.

In some embodiments transmitting a customized message to the calling party based on the received message selection indication and the determined identity of the calling party includes receiving a list of one or more potential callers, each listed potential caller being associated with at least one predefined message, the at least one predefined message being associated with a particular message selection indication, determining that the determined identity of the calling party matches an identity of one of the listed potential callers and transmitting a selected one of the at least one predefined messages associated with the matching listed potential caller, the selected one of the at least one predefined messages being associated with the received message selection indication from the subscriber.

In some embodiments transmitting a customized message to the calling party based on the received message selection indication and the determined identity of the calling party includes receiving a list of one or more predefined default messages, the one or more predefined default messages being associated with a particular message selection indication, determining that the determined identity of the calling party does not match an identity of one of the listed potential callers and transmitting a selected one of the at least one predefined default messages, the selected one of the at least one predefined default messages being associated with the received message selection indication from the subscriber.

The method can also include determining that the participation of the subscriber in the first call has ended and connecting the second call leg to user equipment of the subscriber.

Some embodiments include a method for processing a second call leg directed to a subscriber that is participating in a first call that includes receiving the second call leg at an MSC serving the subscriber, receiving subscriber profile information associated with the subscriber at the MSC, determining, from the received subscriber profile information, if services provided to the subscriber include a call answering and holding feature, transmitting an indication to the subscriber that the second call leg is available if the services provided to the subscriber include the call answering and holding feature, processing the second call leg without call answering and hold functions if the services provided to the subscriber do not include the call answering and holding feature, receiving a call treatment indication from the subscriber if the indication that the second call leg is available was transmitted, processing the second call leg without call answering and hold functions if the call treatment indication from the subscriber so directs, transmitting a default message to a caller associated with the second call leg if the call treatment indication so directs, transmitting a selected message from one or more predefined messages included in the subscriber profile information to the caller associated with the second call leg if the call treatment indication so directs, receiving an election indication from the caller associated with the second call leg and, placing the second call leg on hold if the received election indication so directs.

Transmitting the indication to the subscriber that the second call leg is available can include determining an identity of a calling party associated with the second call leg and transmitting an indication of the identity of the calling party to the subscriber.

Sometimes transmitting the selected message includes determining an identity of a caller associated with the second call leg and transmitting a message selected based on the identity of the caller and the received call treatment indication.

Receiving the call treatment indication can include receiving a message based on key presses made on a keyboard of user equipment of the subscriber, thereby indicating selected message.

In some embodiments receiving the call treatment indication comprises receiving no response from the subscriber, thereby indicating default call treatment.

A system for processing a second call leg directed to a subscriber that is participating in a first call includes means for receiving the second call leg directed to the subscriber, means for determining that the subscriber subscribes to a call answering and holding feature, means for determining whether the subscriber desires to place the second call leg on hold, means for transmitting a message to a calling party associated with the second call leg offering to place the second call leg on hold if the subscriber desires to place the second call leg on hold, means for receiving an indication that the calling party accepts the offer to be placed on hold if the message to the calling party is transmitted, means for placing the second call leg on hold if the indication that the calling party accepts the offer is received, and means for indicating to the subscriber that the second call leg is available, if at the time of indication, the second call leg is available.

The means for indicating to the subscriber that the second call leg is available can be operative before the means for transmitting the message to the calling party associated with the second call leg.

In some embodiments the means for determining whether the subscriber desires to place the second call leg on hold includes means for receiving an indication that the subscriber does not desire that the second call leg be placed on hold and therefore preventing the transmission of the message to a calling party associated with the second call leg offering to place the second call leg on hold.

In some embodiments the means for determining whether the subscriber desires to place the second call leg on hold includes means for receiving an message selection indication from the subscriber, thereby receiving an indication that the subscriber does desire that the second call leg be placed on hold and the means for transmitting the message to the calling party associated with the second call leg includes means for transmitting a customized message to the calling party based on the received message selection indication.

Sometimes the means for determining whether the subscriber desires to place the second call leg on hold includes means for receiving a message selection indication from the subscriber, thereby receiving an indication that the subscriber does desire that the second call leg be placed on hold and means for determining an identity of the calling party. In some of these instances the means for transmitting the message to the calling party associated with the second call leg includes means for transmitting a customized message to the calling party based on the received message selection indication and the determined identity of the calling party.

The means for determining whether the subscriber desires to place the second call leg on hold can include means for determining and identity of the calling party, means for transmitting the determined identity of the calling party to the subscriber, means for receiving a message selection indication from the subscriber, thereby receiving an indication that the subscriber does desire that the second call leg be placed on hold. In some of these embodiments the means for transmitting the message to the calling party associated with the second call leg includes means for transmitting a customized message to the calling party based on the received message selection indication and the determined identity of the calling party.

The means for determining whether the subscriber desires to place the second call leg on hold can include means for receiving information from a subscriber profile of the subscriber indicating that the subscriber desires to place on hold all second calls received while the subscriber is participating in any other call.

The means for transmitting a customized message to the calling party based on the received message selection indication and the determined identity of the calling party can include means for receiving a list of one or more potential callers, each listed potential caller being associated with at least one predefined message, the at least one predefined message being associated with a particular message selection indication, means for determining that the determined identity of the calling party matches an identity of one of the listed potential callers and means for transmitting a selected one of the at least one predefined messages associated with the matching listed potential caller, the selected one of the at least one predefined messages being associated with the received message selection indication from the subscriber.

Sometimes the means for transmitting a customized message to the calling party based on the received message selection indication and the determined identity of the calling party includes means for receiving a list of one or more predefined default messages, the one or more predefined default messages being associated with a particular message selection indication, means for determining that the determined identity of the calling party does not match an identity of one of the listed potential callers and means for transmitting a selected one of the at least one predefined default messages, the selected one of the at least one predefined default messages being associated with the received message selection indication from the subscriber.

In some embodiments the system also includes means for determining that the participation of the subscriber in the first call has ended and means for connecting the second call leg to user equipment of the subscriber.

For instance, some embodiments include a system for processing a second call leg directed to a subscriber that is participating in a first call. The system includes a profile interpreter, a subscriber interface, a second caller interface and a hold manager. For example, the profile interpreter can be operative to receive a subscriber profile, determine if the subscriber subscribes to a call answering and holding feature, determine settings of call answering and holding feature configuration parameters, and provide access to one or more messages stored in the subscriber profile. The subscriber interface can be operative to transmit information regarding the second call leg to the subscriber according to the configuration parameter setting, and to receive and interpret indications from the subscriber regarding call treatment directions. The second caller interface can be operative to signal a second caller associated with the second call leg according to the configuration parameters and/or the call treatment indications and to receive calling party call treatment indications from the second caller and the hold manager can be operative to place the second call leg on hold according to the configuration parameters, the subscriber call treatment directions, and/or the calling party call treatment indications.

In some embodiments the subscriber interface is operative to transmit calling line identification information to the subscriber regarding second call leg. Additionally, or alternatively the subscriber interface can be operative to receive a message selection indication from the subscriber regarding a message to be transmitted to the second caller.

The second caller interface can be operative to transmit a message to the second caller based on an indication received from the subscriber and calling line identification information regarding the second call leg.

In some embodiments the profile interface and the second caller interface cooperate to compare the calling line identification information to information included in a predefined list of potential callers and to select the transmitted message based on whether or not an entry in the list of potential callers includes information matching the calling line identification information.

### BRIEF DESCRIPTION OF THE DRAWINGS

The invention may take form in various components and arrangements of components, and/or in various procedures and arrangements of procedures. The drawings are only for purposes of illustrating preferred embodiments. They are not to scale, and are not to be construed as limiting the invention.

FIG. 1 is a flow chart outlining a method for processing a second call leg directed to a subscriber that is already engaged in a first call.

FIG. 2 is a flow chart outlining an embodiment of the method of FIG. 1.

FIG. 3 is a call flow diagram illustrating a first portion of a call processing scenario associated with the method of FIG. 1.

FIG. 4 is a call flow diagram illustrating a possible second portion of a call processing scenario associated with the method of FIG. 1.

FIG. 5 is a call flow diagram illustrating a possible third portion of a call processing scenario associated with the method of FIG. 1.

FIG. 6 is a block diagram outlining an exemplary system operative to process a second call leg directed to a subscriber that is already engaged in a first call.

### DETAILED DESCRIPTION OF THE INVENTION

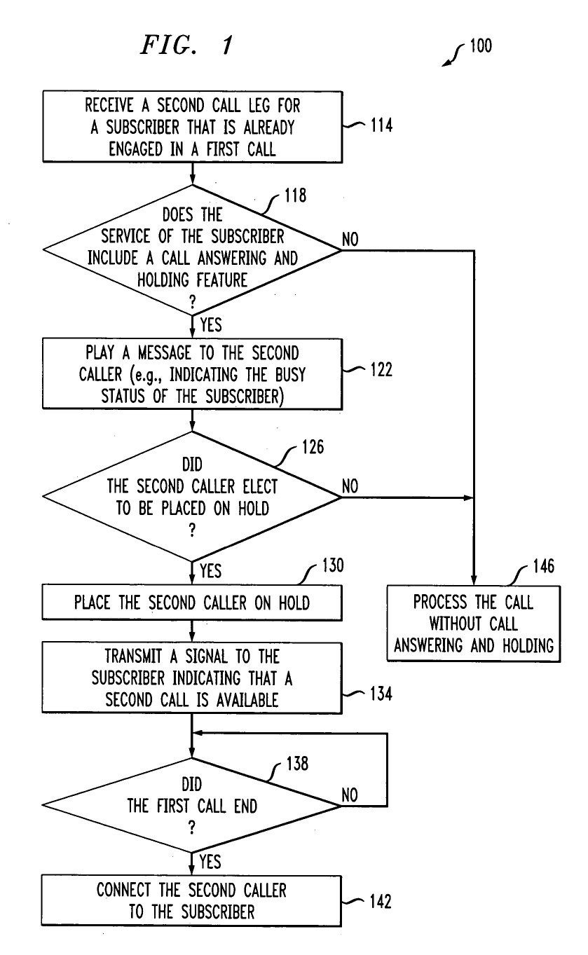

Referring to FIG. 1, a method 100 for processing a second call to a subscriber when the subscriber, or the user equipment of the subscriber, is busy or already engaged in a first call includes receiving 114 a second call leg for a subscriber that is already engaged in a first call, determining 118 if the subscriber subscribes to, or is entitled to, a call answering and holding feature, playing 122 a message to a second caller associated with the second call leg. If the subscriber subscribes to or is entitled to a call answering and holding feature, determining 126 if the second caller elects to be placed on hold, placing 130 the second caller on hold, if 126 the second caller elected to be placed on hold, and transmitting 134 a signal to the subscriber, or user equipment thereof, indicating that the second call or call leg is available. The method 100 may also include determining 138 whether the first call has ended. If 138 the first call has ended, the method 100 can include connecting 142, the second caller to the subscriber or connecting the second call leg to the user equipment of the subscriber. If 118, the subscriber does not subscribe to a call answering and holding feature or if 126 the subscriber does not elect to place the second call leg on hold, then the second call is processed 146 without call answering or holding.

Receiving 114, a second call leg for a subscriber that is already engaged in a first call, includes determining or having knowledge that the subscriber, or the user equipment of the subscriber, is already engaged in a first call. This information is readily available in communications networks. For example, where the second call leg is received 114 in a Mobile Switching Center (MSC), an Administrative Call Processing and Database Node (ACDN) associated with the MSC includes status information regarding the user equipment of the subscriber. The ACDN, and therefore the MSC, knows when the user equipment of the subscriber is “off-hook” or engaged or busy in a call.

Determining 118 if the subscriber is entitled to, or subscribes to, a call answering and holding feature can include a determination that all subscribers are entitled to the call answering and holding feature. Alternatively, the determination can be based on a review of individual records associated with the subscriber. Additionally, individual records of the subscriber can be reviewed to determine configuration parameters associated with the call answering and holding feature. This is true whether the service is universally available or only available to subscribers that elect or subscribe to the call answering and holding feature.

Playing 122, a message to the second caller, can include playing a ringing signal to the second caller. For instance, in prior art systems, or where the call answering and holding feature is not invoked, a busy signal would be transmitted to a second caller associated with a second call leg for a subscriber, or user equipment of a subscriber, that is already engaged in a first call. When a call answering and holding feature is invoked, it may be necessary to transmit a ringing signal or other indication of call processing to the second caller, while determinations (e.g. 118) are made with regard to the call answering and holding feature. Alternatively, playing 122 the message to the second caller can include a notification, such as a voice notification that the subscriber or user equipment of the subscriber is currently engaged and offering to place the second caller, or the second call leg associated therewith, on hold. A message played 122 to the second caller may also include instructions explaining to the second caller how to indicate a desire or an election to be placed on hold.

For example, a second call leg may be placed on hold if the second caller simply stays on the line for some predefined period of time. Alternatively, the second caller may elect to be placed on hold by pressing a key associated with the user equipment of the second caller or by some other user input means associated with the user equipment. The determination 126 is made by monitoring the second call leg for the predefined response. If the response is received, then the second call leg is placed 130 on hold. If the response is not received after some predefined period of time, the call is processed 146 without further call answering or holding functionality.

Placing 130 the second caller on hold, can include, for example, terminating the second call leg at a switching center. Such a termination can include providing silence or playing some message or entertainment to the calling party associated with the second call leg. For instance, an advertisement might be played to help defray the cost of the call answering and holding feature. Alternatively, music or other programming may be provided.

Transmitting 134, a signal to the subscriber indicating that the second call is available, can include transmitting a tone, click or other audio indication that the second call leg is available. Additionally, or alternatively, calling line or other calling party identification information may be transmitted to the subscriber, or to user equipment thereof. For example, a name or calling line directory number associated with the second call leg may be displayed on a display device associated with the user equipment of the subscriber. The subscriber may use this information in deciding whether to continue or end the first call, or accelerate the exchange of information in the first call in order to accept the second call. As will be described in greater detail below, in embodiments where the signal to the subscriber is transmitted 134 earlier in the process the subscriber can use the information in determining whether or not to invoke the call answering and holding feature, and even in determining the content of the message played 122 to the second caller.

The determination 138 as to whether the first call has ended can be made automatically or can be based on further subscriber input. For example, the ACDN is notified when the call with the first party ends. The second caller, or the second call leg, may be connected to the user equipment of the subscriber based on that information alone. Alternatively, the call answering and holding feature can be configured to require an indication from the subscriber that the subscriber is ready to accept the second call. For instance, the subscriber may use a user interface associated with the user equipment of the subscriber to enter an indication or direction to connect 142, the second call leg.

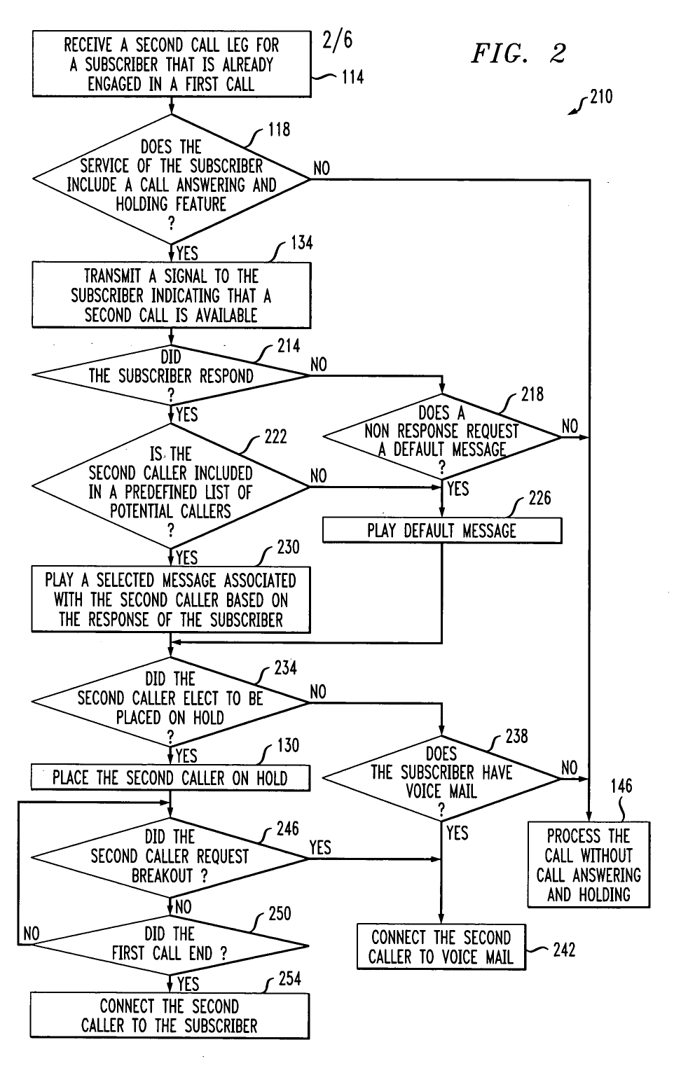

Referring to FIG. 2, an embodiment 210 of the method 100 begins with the reception 114 of a second call leg for a subscriber that is already engaged in a first call. For example, the second call leg is received 114 at a Mobile Switching Center (MSC). A determination 118 is made as to whether or not the subscriber is entitled to, or subscribes to, a call answering and holding feature. For instance, the MSC queries a subscriber database associated with the subscriber and retrieves a subscriber profile, or information from the subscriber profile, of the subscriber. For example, the information from the subscriber profile includes the state of a call answering and holding feature activation bit, as well as call answering and holding feature configuration parameters. If the subscriber is entitled to, or subscribes to, the call answering and holding feature, and if, for example, the call feature parameters indicate that the feature is currently turned on, a signal is transmitted 134 to the subscriber indicating that a second call is available. For instance, if the subscriber is also entitled to, or subscribes to, a caller ID feature, then some indication of the identity of the caller associated with the second call leg is transmitted to the user equipment of the subscriber. Alternatively, if the subscriber is not entitled to caller identification information, a call holding tone or signal is transmitted to the user equipment of the subscriber. The subscriber may elect to respond or not to respond to this signal.

A determination 214 is made as to whether the subscriber has responded to the transmitted 134 signal. If the subscriber does not respond, a determination 218 is made as to the meaning of a non-response. If the subscriber does respond, a determination 222 is made as to whether the second caller is included in a predefined list of potential callers associated with the subscriber.

For example, the determination 218 as to the meaning of a non-response from the subscriber can be made based on the value of one or more call answering and holding feature configuration parameters. For instance, a non-response from the subscriber may indicate that the subscriber wishes to process 146, the call without automatic call answering and holding. For example, the second call leg may be provided with a busy signal. Alternatively, if the subscriber is entitled to or subscribes for a voicemail service, processing 146 without call answering and holding, may include offering the caller associated with the second call leg the opportunity to leave a voicemail message. Alternatively, the determination 218 may be made that a non-response from the subscriber indicates a direction for default call answering and holding processing.

For example, default call answering and holding processing, may include the transmitting 226 of a default message to the caller associated with the second call leg. The default message may be generic in nature and played to all second callers for whom the subscriber indicates or directs default processing. Alternatively, the transmitted or played 226 default message may be selected from a plurality of such default messages predefined and associated with the identity of the second caller. That is, the subscriber may predefine customized messages for listed potential callers, the combination of a default processing indication and an identity associated with the second caller (such as a calling line identification) addresses or selects the appropriate default message.

For example, a default message may simply explain that the subscriber is currently on the phone and offers the caller the opportunity to be placed on hold. Customized default messages may include similar information but may address the caller by name and/or include other personalized information.

If 214 the subscriber does respond to the transmitted 134 signal, the response may simply indicate that the call answering and holding feature should be activated and used to process the current second call leg. Additionally, or alternatively, the response may indicate a message selection. For instance, if the response of the subscriber was the pressing of a “1” key on a keyboard associated with the user equipment of the subscriber, this may select a first message or a first class of messages. For example, a first message or a first class of message may indicate that the subscriber is almost finished with the first call and request that the calling party associated with the second call leg elect to be placed on hold. Pressing a “2” key on the keyboard associated with the user equipment of the subscriber may select a second message or second class of messages. For instance, the second message or second class of messages may indicate that the subscriber will probably be engaged in the first call for another five minutes, or other relatively short period of time, and offer the caller associated with the second call leg the opportunity to be placed on hold. Pressing the “3” key might indicate or direct the transmission of a third message or a message from a third class of messages. For example, the third message or third class of messages might indicate that the subscriber will be occupied in the first call for an extended period of time and recommend the caller associated with the second call leg not wait on hold, but offer the opportunity to do so.

The determination 222 as to whether the second caller is included in a predefined list of potential callers includes determining an identity associated with the second caller. For example, a calling line identification or caller ID associated with the second call leg is determined. That identification is compared with identifications included in the predefined list of potential callers. If the identification information of the second caller matches one of the entries in the predefined list of potential callers, then the response of the subscriber can be used to identify a customized message that is meant specifically for the identified second caller.

For instance, if the subscriber is a parent, the subscriber may predefine a class 1 message (e.g., a message associated with a “1” key press response 214) specific for a child calling from a child's cell phone. Additionally, or alternatively, a class 1 message may be prerecorded or predefined for any household member calling the cell phone of a subscriber from the home phone of the subscriber. Of course, class 2 (e.g., associated with the 2 key) and class 3 messages (e.g., associated with the 3 key) can also be predefined. Furthermore, additional classes of messages can be supported. There is no requirement that the predefined messages be related to the subscribers estimate for the remaining length of the first call. For instance, the subscriber may predefine messages in anticipation of the purpose of the call of the members of the predefined list of potential callers.

For example, the subscriber may anticipate that a second call leg associated with a spouse of the subscriber is in regard to dinner plans. Therefore, the class 1 message associated with the spouse's identity may indicate that the subscriber anticipates being home on time. The predefined class 2 message might indicate that the subscriber anticipates being home late and the class 3 message may indicate that the subscriber intends to be home early.

If 222, the identity associated with the second calling party does not match any of those identities included in the predefined list of potential callers, then default message 226 is played to the second caller. Default messages may also be predefined and associated with classes or specific key presses. For example, pressing the one key may indicate or direct that a generic or default message be played indicating that the subscriber is almost finished with the first call and that it is recommended that the calling party associated with the second call leg elect to be placed on hold. A second default or generic message may indicate to an unknown or at least unexpected second caller that the subscriber will be engaged in the first call for a somewhat longer period of time. Additional default or generic messages can also be predefined and associated with other key presses or combinations of key presses or other user interface input.

If the subscriber indicates or directs that the call answering and holding feature should be applied to the current second call either a selected message associated specifically with the second caller is played 230 or a default or generic message is played 226.

After the message is played 230, 226 a determination 234 is made as to whether the second caller elects to be placed on hold. For example, if the second caller does not hang up after the message is played 226, 230, it can be interpreted as an indication that the second caller elects to be placed on hold. Alternatively, the played 226, 230 messages can include instructions directing the second caller to press a particular key or provide other equivalent user interface input to indicate a request or election to be placed on hold.

A second key press or equivalent user interface input can be used to indicate another call processing preference. For example, if the second caller does not elect to be placed on hold, a determination 238 is made as to whether the subscriber is entitled to or subscribes to voicemail services. For example, subscriber profile information associated with a subscriber is examined to determine if the subscriber subscribes to a voicemail service.

If the subscriber is entitled to voicemail services, the second caller may be connected 242 to the voicemail service of the subscriber. If it is determined 238 that the subscriber is not entitled to voicemail services, or if the second caller elects not to use voicemail services, then the call is processed 146 without further call answering and holding processing.

If 234 the second caller does elect to be placed on hold, then the second call leg is placed 130 in a hold state as described with reference to FIG. 1.

At any time while the second call leg is in a hold state, the second caller may break out of hold. For example, the played 226, 230 message includes directions indicating that a particular key press or other user interface input can be used to break out of hold and, for example, connect 242 the second call leg to a voicemail or other call processing feature to which the subscriber is entitled. Therefore, while the second call leg is in a hold state, continuous or regular determinations 246, 250 are made as to whether the second caller has requested a breakout 246 and whether 250, the subscriber has become disengaged from the first call. If 246 the second caller provides the prescribed indication requesting a breakout, the second call leg is removed from the hold state and connected, for example, to voicemail or handled in some other predefined matter.

If 250, the first call is ended, then as described with reference to FIG. 1, the second call leg is connected 254 to the user equipment of the subscriber.

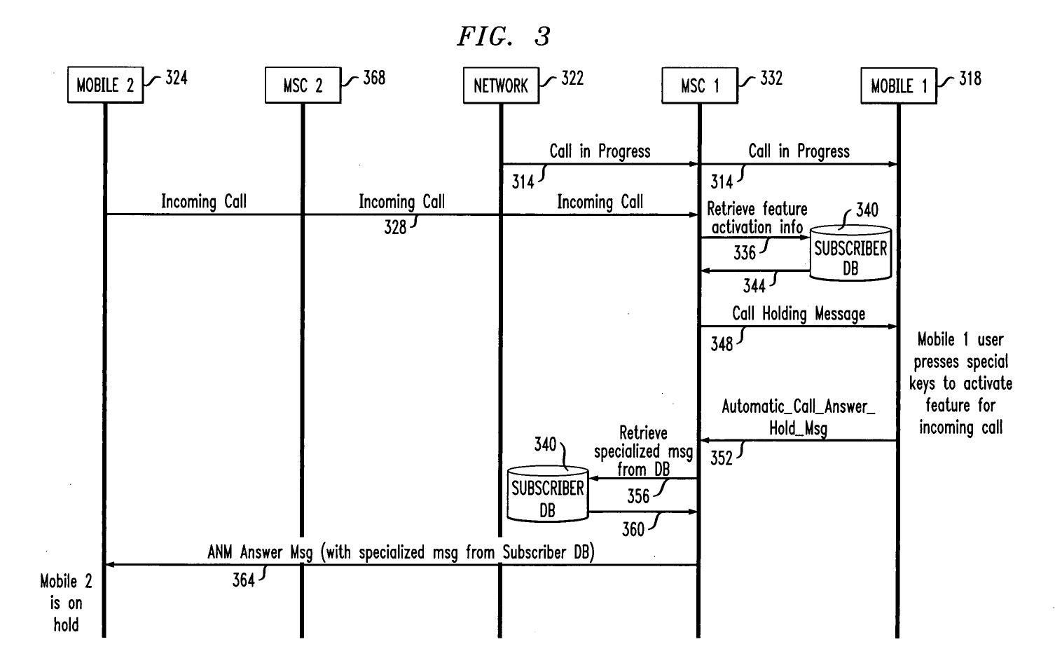

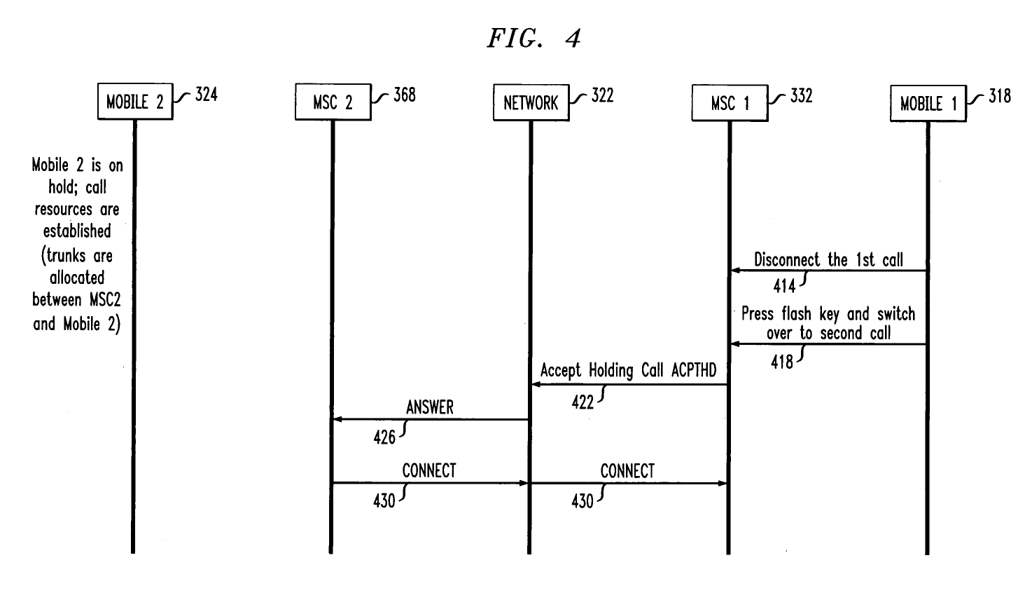

For instance, referring to FIG. 3-FIG. 5, a subscriber is engaged in a call 314 using user equipment 318 to communicate with a first caller (not shown) through a network 322. A second caller (not shown), desiring to communicate with the subscriber, uses user equipment 324 of the second caller to place a call 328 to the subscriber. For example, an Incall message is received 114 at a switching center, such as, for example, a Mobile Switching Center 332 serving the user equipment 318 of the subscriber. The MSC 332 includes or is in communication with an Administrative Call Processing and a Database Node (ACDN) and is therefore aware or determines the busy status of the user equipment 318 of the subscriber. Therefore, the MSC 332 serving the user equipment 318 of the subscriber transmits a database query 336 to a subscriber database 340 associated with the subscriber. The database query 336 requests information from a subscriber profile associated with a subscriber. The requested information includes, for example, the state of a call answering and holding feature activation bit. Additional information may be requested as well. The subscriber database 340 responds by transmitting a query response message 344. The MSC 332 processes the response message 344 and determines 118 that, in this scenario, the services of the subscriber do include a call answering and holding feature. Therefore, the MSC 332 transmits 134, a Call Holding message 338 to the user equipment 318 of the subscriber. For example, the Incall message associated with the incoming call 328 includes calling line identification digits. These digits are transmitted to the user equipment 318 of the subscriber. The user equipment 318 presents the digits in a display associated with the user equipment 318. Additionally, or alternatively, a tone or click associated with the call answering and holding feature is added to the audio signal being transmitted to user equipment 318 as part of the Call Holding message 348. Alternatively, the calling line identification digits may be used to access an identity database record and a name or other text string is retrieved and included in the Call Holding message 348.

The Subscriber uses the information transmitted in the call holding message in making a decision about how to process the second call 328. For example, the subscriber may decide not to respond to the Call Holding message 348, in which case the determination 218 is made as to the meaning of a non-response. Alternatively, the subscriber may acknowledge the Call Holding message 348 by, for example, pressing a key on a key pad associated with the user equipment 318. The key press may simply acknowledge the call holding message and direct the MSC to play or transmit a standard or default message inviting the second caller to be placed on hold. Alternatively, the key press may partially or completely address or select a particular custom or personal message to be played for the second caller.

In the exemplary scenario, the subscriber responds to the Call Holding message 348 by pressing a key on the user equipment 318. The user equipment 318 generates and transmits an Automatic_Call_Answer_Hold_Message 352 to the MSC 332 serving the user equipment 318. The MSC 332 then determines 214 that the subscriber has responded and takes steps to process that response. For example, the MSC 332 examines information in the subscriber profile of the subscriber in order to interpret the key press made by the subscriber. The MSC 332 may examine information that was included in the query response message 344 or may generate and transmit a second subscriber database query 356 to retrieve the required subscriber profile information. If the second subscriber database query message 356 is transmitted, the subscriber database 340 generates and transmits a second database query response message 360 to the MSC 332 serving the user equipment 318 of the subscriber.

For example, the subscriber database information may associate the particular key pressed by the subscriber with a particular set or class of messages. Another piece of information may be used to select an appropriate message from among the messages that make up the set or class. For example, the calling line identification digits associated with the incoming call 328 may be used to identify the appropriate message from within the selected class. For instance, if the subscriber profile information includes a list of potential callers, the determination 222 is made as to whether the second caller is associated with information contained in the predefined list of potential callers. For example, each entry in the list includes calling line identification numbers and calling line identification information associated with the incoming call is compared to those entries. If a matching entry is found, then a message for that entry that is selected by the key press made by the subscriber is accessed. For instance, the message is included in an ANM Answer message 364 that is transmitted by the MSC 332 to the user equipment 324 of the second caller. For example, the calling line identification digits indicate that the second caller is a relative, such as a child, of the subscriber. Based on the information included in the Call Holding Message 348 and, perhaps the time of day, the subscriber makes an educated guess regarding the purpose of the second caller's call and selects an appropriate message based on that assumption. For example, the message might say “I am on the phone right now, but I see that you are calling to check in. If you need to tell me something more than that, please stay on the line, I should only be about 2 more minutes”. Of course, if the first call 314 is likely to take longer than two more minutes, then the subscriber may have selected another class of message expressing similar information but warning of the extended delay. Yet another class of messages may recommend leaving a voicemail message or promise to call the second caller back promptly.

In the exemplary scenario, a selected message is played 230 or transmitted to the second caller and the determination 234 is made that the second caller elects to be placed on hold. Therefore, the second caller is placed 130 on hold. For instance, call resources, such as trunks, are allocated between the user equipment 324 of the second caller and a switch, such as a second mobile switching center 368 serving the user equipment 324 of the second caller.

The second caller may be provided with an entertainment such as music or other programming while on hold. In some embodiments, the established resources are used to deliver commercial messages to the second caller. For instance, revenue from the commercial messages may be used to defray some or all of the costs associated with providing the call answering and holding feature. Additionally, reminder signals, such as short beeps or tones may be transmitted to the user equipment 318 of the subscriber to inform the subscriber of the holding status of the second caller.

When the subscriber or a final other participant in the first call 314 drops or disconnects 414 their respective call leg from the first call 314, the MSC 332 serving the user equipment 318 of the subscriber may complete a connection between the second caller and the subscriber. For example, the ACDN (not shown) associated with the MSC 332 serving the user equipment 318 of the subscriber registers the availability of the user equipment 318 of the subscriber. The MSC may then alert the user equipment 318 and connect 142 the holding call leg when the subscriber responds to the alert. Alternatively, as illustrated in the exemplary embodiment, the subscriber may send a signal 418 to the MSC 332 serving the user equipment 318 of the subscriber by, for example, pressing a FLASH key associated with the user equipment 318 of the subscriber, to indicate a readiness of the subscriber to receive the second call. The means for initiating the holding call connection process may be determined by a service provider of the subscriber or may be determined by configuration information received in a database query response message (e.g., 344, 360).

When the holding call connection process is triggered or initiated, the MSC 332 serving the user equipment 318 of the subscriber transmits and Accept Holding Call message (ACPTHD) to the network 322 interconnecting the MSC 332 serving the user equipment 318 of the subscriber and the MSC 368 serving the user equipment 324 of the second or holding caller. The network 322 responds to the Accept Holding Call message 422 by transmitting an Answer message 426 to the MSC 368 serving the user equipment 324 of the second or holding caller. The MSC 368 serving the user equipment 324 of the second or holding caller acknowledges the Answer message 426 by transmitting a Connect message 430 to the MSC 332 serving the user equipment 318 of the subscriber. The connect message 430 directs the completion of a connection between the first MSC 332 and the second MSC 368 and the user equipment 318, 324 of the subscriber and the second caller.

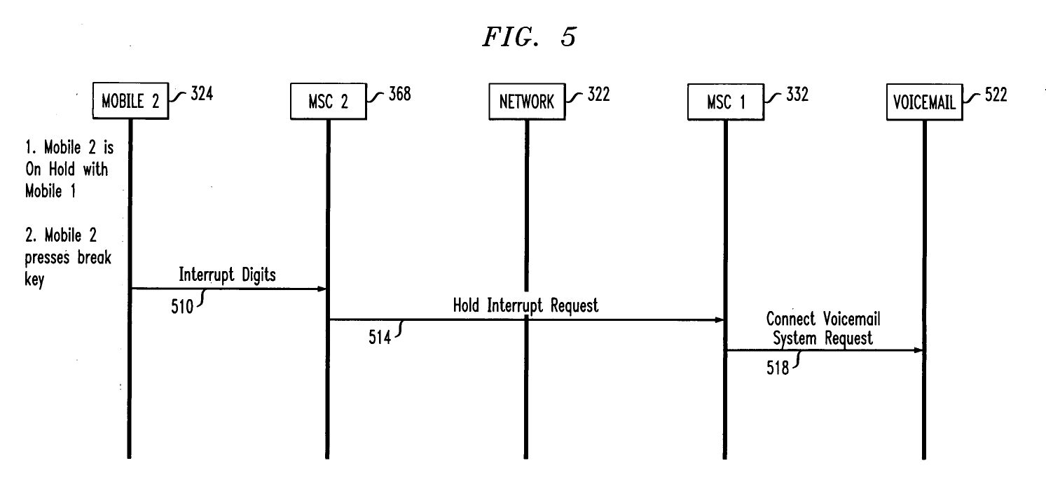

Referring to FIG. 5, if the subscriber is entitled to, or subscribes to, another call treatment feature, the second or holding caller may decide to break out of hold and be connected to one or more of those other features. For instance, the message transmitted or played 230 to the second caller may explain how to be switched to a voice mail or other feature. While on hold, the second caller may transmit an indication that the second caller is no longer willing or able to remain on hold. For example, the second caller presses keys or activates other user input devices associated with the user equipment 324 of the second caller and a message, including, for example, Interrupt Digits 510 is transmitted to the MSC 368 serving the user equipment 324 of the second caller. Based on the Interrupt Digits 510, the MSC 368 serving the user equipment 324 of the second caller transmits a Hold Interrupt Request message 514 to the MSC 332 serving the user equipment 318 of the subscriber. Based on the Hold Interrupt Request message 514, the MSC 332 serving the user equipment 318 of the subscriber determines 246 that the second caller requested the breakout from hold to a voice mail service of the subscriber. In response, the MSC 332 serving the user equipment 318 of the subscriber transmits a connect voicemail system request message 518 to a voicemail server 522 associated with the subscriber (for example, by configuration information included in the subscriber profile) and the user equipment 324 of the second caller is connected to the voicemail server 522 as is known in the voicemail art.

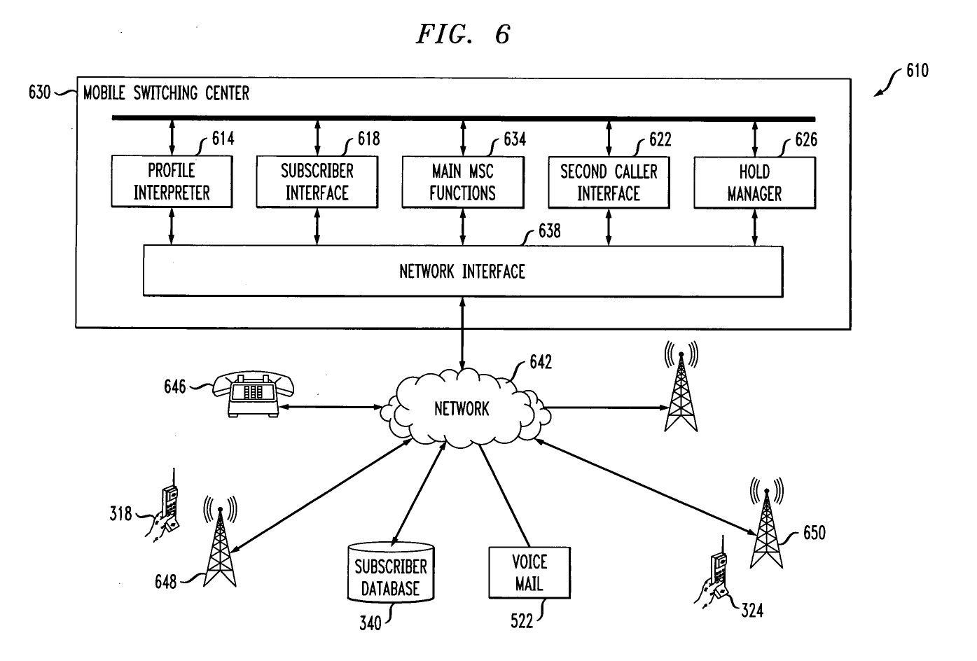

Referring to FIG. 6, an exemplary system 610 operative to provide a call answering and holding service includes a profile interpreter 614, a subscriber interface 618, a second caller interface 622 and a hold manager 626.

For instance, the system 610 is implemented within a Mobile Switching Center (MSC 630) including standard MSC functions 634 and a network interface 638. The network interface 638 connects the main MSC functions 634, as well as the profile interpreter 614, subscriber interface 618, second caller interface 622, and a hold manager 626 to a plurality of network nodes through the services of an intervening network 642. For example, the elements 614, 618, 634, 622, 626 and 638 of the Mobile Switching Center 630 can communicate with the user equipment 318 of the subscriber, the user equipment 646 of one or more first callers or called parties, the user equipment 324 of the second caller, and the voicemail server 522 associated with a voicemail service of the subscriber.

The profile interpreter 614 is operative to access information regarding communication service features subscribed for by the subscriber. For instance, the profile interpreter 614 generates and transmits database queries (e.g., 336, 356) and receives database query return results (e.g., 344, 360), analyzes the returned information and determines 118 whether or not the subscriber subscribes to, or is entitled to, a call answering and holding feature. Additionally, the profile interpreter 614 participates in the determination 218 as to the meaning of a non-response from the subscriber and in the determination 222 as to whether the second caller is included in a predefined list of potential callers. The profile interpreter 614 may also be involved in the determination 246 as to whether a holding party has requested a hold to breakout and as to whether or not 234, the second caller elects to be placed on hold.

The subscriber interface 618 is operative to communicate with the subscriber. The subscriber interface 618 may rely on the services of the profile interpreter in interpreting subscriber responses. For instance, the subscriber interface 618 transmits 134 the signal to the subscriber indicating that the second caller is available when the subscriber interface 618 is so informed by the profile interpreter 614 and/or the main MSC functions 634. Additionally, the subscriber interface 618 determines 214 if the subscriber responds to the transmitted 134 signal and accesses the profile interpreter 614 to determine a meaning of a particular subscriber response or non-response.

The second caller interface 622 is operative to communicate with the second caller. For example, the second caller interface 622 is informed by the subscriber interface 618 and/or the profile interpreter 614 as to the content or location of a message to be played or transmitted to the second caller or user equipment 324 thereof. The second caller interface 622 then transmits or plays 230, 226 the selected message. The second caller interface 622 also determines 234 if the second caller elects to be placed on hold. For example, the second caller interface 622 interprets key press information received from the second caller by communicating with the profile interpreter 614. Alternatively, if so directed by the profile interpreter 614, the second caller interface 622 determines 234 that the second caller desires to be placed on hold by determining that the second caller has remained on the line after receiving the transmitted or played 230, 226 messages. When the second caller interface 622 determines that the second caller elects to be placed on hold, the second caller interface 622 passes processing to the hold manager 626.

The hold manager 626 allocates, or maintains the allocation of, resources required to place the second caller on hold. Additionally, the hold manager 626 accesses the profile interpreter 614 to determine 246 if input received from the second caller is associated with the breakout request or a request for other call treatment options. The hold manager 626 also determines 250, if or when the first call ends, and/or, if the subscriber has indicated a readiness to accept the second call.

For example, when the main MSC functions 634 receive a second call leg for a subscriber that is already engaged in a first call, the main MSC functions 634 notify the profile interpreter that the second call leg has been received. The profile interpreter 614 accesses the subscriber database 340, through, for example, a database query (e.g., 336) requesting subscriber profile information. The subscriber database 340 provides the requested information, for example, in a database query response message (e.g., 344). Where the subscriber is entitled to call answering and holding services, the profile interpreter 614 so informs the main MSC functions 634 and the subscriber interface 618. The subscriber interface 618 transmits 134 a signal to the subscriber indicating that a second call is available. For instance, the main MSC functions 634 provide the subscriber interface 618 with calling line identification information regarding the second caller and the subscriber interface 618 transmits 134 that information, in conjunction with a call holding tone or sound, to the user equipment 318 of the subscriber through the services of the network interface 638, the network 642, and a first base station 648. The subscriber interface 618 waits for a response from the subscriber. If no response is received within a predetermined period of time, the subscriber interface 618 queries the profile interpreter 614 to determine 218 if a non-response is a request for processing 146, the call without call answering and holding or is a request for default processing 226. If a non-response is a request for default processing 226, the subscriber interface so notifies the second caller interface 622. If a non-response is a request for processing 146 without call answering and holding, the subscriber interface 618 so notifies the main MSC functions 634.

If the subscriber interface 618 detects a subscriber response before the predetermined time period elapses, the subscriber interface 618 receives the response and accesses the profile 614 interpreter to determine the meaning of the response. For example, the profile interpreter 614 retrieves a table relating potential key presses from the subscriber to one or more call answering messages to be played 230, 226 to second callers. Based on a comparison between the subscriber response received by the subscriber interface 618 and the table of response definitions retrieved by the profile interpreter 614 an appropriate message for the second caller is selected. The selected message is transferred to the second caller interface 622 or the second caller interface 622 is provided with a pointer, index or address for accessing the selected message. The second caller interface 622 uses the transferred information to play or transmit 226, 230 the appropriate message to the second caller or user equipment 324 thereof through the services of the network interface 638, the network 642 and a base station 650 serving the second caller.

Of course, if user equipment used by the second caller is wire line based, the base station 650 is not required.

After transmitting or playing 230, 226 the selected or appropriate message, the second caller interface 622 determines 234 whether or not the second caller elects to be placed on hold. For instance, the second caller interface 622 determines if the second caller has provided user interface input, such as a key press, or utterance, requesting to be placed on hold, or if the user equipment 324 of the second caller has remained active for a predefined period of time thereby indicating a desire to be placed on hold. One or more of these actions may be specified in the subscriber profile as an indication of an election to be placed on hold. This profile information is used by the profile interpreter 614, to translate second caller responses for the second caller interface 622. If the second caller does not elect to be placed on hold, the second caller interface 622 transfers call processing to the main MSC functions 634 which may determine 238 if the subscriber has voicemail. If the subscriber does have voicemail the second caller may be connected 242 to the voicemail server 522. Alternatively the main MSC functions 634 process 146 the second call without further call answering and holding features.

If the second caller elects to be placed on hold, the second caller interface 622 passes processing to the hold manager 626. The hold manager 626 allocates or maintains resources thereby placing 130, the second caller or second call leg on hold. For instance, hold manager 626 directs a switching center such as the mobile switching center 368 (within the network 642) to maintain a connection with the user equipment 324 of the second caller and to report to the mobile switching center 630 any user input the second mobile switching center 368 receives from the user equipment 324 of the second caller. If the hold manager 626 receives a report of user input from the user equipment 324 of the second caller through the services of the second MSC 368, the hold manager 626 accesses the profile interpreter 614 to determine 246 if the received user input is a request to break out of hold and to be directed to other call treatment processes such as voicemail. If the user input is a request to break out, the hold manager 626 so informs the main MSC functions 634 and the main MSC functions 634 issue messages to direct the second call leg to be connected, for example, to the voicemail server 522 associated with a subscriber.

Alternatively, the hold manager 626 may be informed by the main MSC functions 634 that the first call has ended, or by the subscriber interface 618 that the subscriber has provided user input (e.g. 418) indicating that the subscriber is ready to receive the second call. The hold manager 626 determines 250 that the first call has ended and directs the main MSC functions 634 to connect 254 the second caller to the subscriber.

Embodiments may be implemented in a wide variety of hardware and software combinations. The system 610 is exemplary only. The procedures outlined in FIG. 1 and FIG. 2 can be carried out by different functional blocks implemented in different system elements. The invention has been described with reference to the preferred embodiments. Obviously, modifications and alterations will occur to others upon a reading and understanding of this specification. It is intended that the invention be construed as including all such modifications and alterations insofar as they come within the scope of the appended claims or the equivalents thereof.

1. A method for processing a second call leg directed to a subscriber that is participating in a first call, the method comprising:
receiving the second call leg directed to the subscriber;
determining that the subscriber subscribes to a call answering and holding feature;
determining whether the subscriber desires to place the second call leg on hold;
transmitting a message to a calling party associated with the second call leg offering to place the second call leg on hold if the subscriber desires to place the second call leg on hold;
receiving an indication that the calling party accepts the offer to be placed on hold if the message to the calling party is transmitted;
placing the second call leg on hold if the indication that the calling party accepts the offer is received; and
indicating to the subscriber that the second call leg is available, if at the time of indication, the second call leg is available.

2. The method of claim 1 wherein indicating to the subscriber that the second call leg is available occurs before transmitting the message to the calling party associated with the second call leg.

3. The method of claim 2 wherein determining whether the subscriber desires to place the second call leg on hold comprises:
receiving an indication that the subscriber does not desire that the second call leg be placed on hold, therefore, not transmitting the message to the calling party associated with the second call leg offering to place the second call leg on hold.

4. The method of claim 2 wherein determining whether the subscriber desires to place the second call leg on hold comprises:
receiving a message selection indication from the subscriber, thereby receiving an indication that the subscriber does desire that the second call leg be placed on hold;
wherein transmitting the message to the calling party associated with the second call leg comprises:
transmitting a customized message to the calling party based on the received message selection indication.

5. The method of claim 2 wherein determining whether the subscriber desires to place the second call leg on hold comprises:
receiving a message selection indication from the subscriber, thereby receiving an indication that the subscriber does desire that the second call leg be placed on hold;
determining an identity of the calling party;
wherein transmitting the message to the calling party associated with the second call leg comprises:
transmitting a customized message to the calling party based on the received message selection indication and the determined identity of the calling party.

6. The method of claim 2 wherein determining whether the subscriber desires to place the second call leg on hold comprises:
determining and identity of the calling party;
transmitting the determined identity of the calling party to the subscriber;
receiving a message selection indication from the subscriber, thereby receiving an indication that the subscriber does desire that the second call leg be placed on hold;
wherein transmitting the message to the calling party associated with the second call leg comprises:
transmitting a customized message to the calling party based on the received message selection indication and the determined identity of the calling party.

7. The method of claim 1 wherein determining whether the subscriber desires to place the second call leg on hold comprises:
receiving information from a subscriber profile of the subscriber indicating that the subscriber desires to place on hold all second calls received while the subscriber is participating in any other call.

8. The method of claim 1 wherein determining whether the subscriber desires to place the second call leg on hold comprises:
receiving information from a subscriber profile of the subscriber indicating that the subscriber desires to place on hold only second calls associated with potential callers included in a predefined list of potential callers;
determining an identity associated with a caller associated with the second call leg; and,
determining if the identity associated with the caller is included in the predefined list of potential callers, thereby determining whether the subscriber desires to place the second call leg on hold.

9. The method of claim 2 wherein transmitting a customized message to the calling party based on the received message selection indication and the determined identity of the calling party comprises:
receiving a list of one or more potential callers, each listed potential caller being associated with at least one predefined message, the at least one predefined message being associated with a particular message selection indication;
determining that the determined identity of the calling party matches an identity of one of the listed potential callers; and,
transmitting a selected one of the at least one predefined messages associated with the matching listed potential caller, the selected one of the at least one predefined messages being associated with the received message selection indication from the subscriber.

10. The method of claim 2 wherein transmitting a customized message to the calling party based on the received message selection indication and the determined identity of the calling party comprises:
receiving a list of one or more predefined default messages, the one or more predefined default messages being associated with a particular message selection indication;
determining that the determined identity of the calling party does not match an identity of one of the listed potential callers; and
transmitting a selected one of the at least one predefined default messages, the selected one of the at least one predefined default messages being associated with the received message selection indication from the subscriber.

11. The method of claim 1 further comprising:
determining that the participation of the subscriber in the first call has ended; and,
connecting the second call leg to user equipment of the subscriber.

12. A method for processing a second call leg directed to a subscriber that is participating in a first call, the method comprising:
receiving the second call leg at an MSC serving the subscriber;
receiving subscriber profile information associated with the subscriber at the MSC;
determining, from the received subscriber profile information, if services provided to the subscriber include a call answering and holding feature;
transmitting an indication to the subscriber that the second call leg is available if the services provided to the subscriber include the call answering and holding feature;
processing the second call leg without call answering and hold functions if the services provided to the subscriber do not include the call answering and holding feature;
receiving a call treatment indication from the subscriber if the indication that the second call leg is available was transmitted;
processing the second call leg without call answering and hold functions if the call treatment indication from the subscriber so directs;
transmitting a default message to a caller associated with the second call leg if the call treatment indication so directs;
transmitting a selected message from one or more predefined messages included in the subscriber profile information to the caller associated with the second call leg if the call treatment indication so directs;
receiving an election indication from the caller associated with the second call leg; and,
placing the second call leg on hold if the received election indication so directs.

13. The method of claim 12 wherein transmitting the indication to the subscriber that the second call leg is available comprises:
determining an identity of a calling party associated with the second call leg; and,
transmitting an indication of the identity of the calling party to the subscriber.

14. The method of claim 12 wherein transmitting the selected message comprises:
determining an identity of a caller associated with the second call leg; and,
transmitting a message selected based on the identity of the caller and the received call treatment indication.

15. The method of claim 12 wherein receiving the call treatment indication comprises receiving a message based on key presses made on a keyboard of user equipment of the subscriber, thereby indicating selected message.

16. The method of claim 12 wherein receiving the call treatment indication comprises receiving no response from the subscriber, thereby indicating default call treatment.

17. A system for processing a second call leg directed to a subscriber that is participating in a first call, the system comprising:
means for receiving the second call leg directed to the subscriber;
means for determining that the subscriber subscribes to a call answering and holding feature;
means for determining whether the subscriber desires to place the second call leg on hold;
means for transmitting a message to a calling party associated with the second call leg offering to place the second call leg on hold if the subscriber desires to place the second call leg on hold;
means for receiving an indication that the calling party accepts the offer to be placed on hold if the message to the calling party is transmitted;
means for placing the second call leg on hold if the indication that the calling party accepts the offer is received; and
means for indicating to the subscriber that the second call leg is available, if at the time of indication, the second call leg is available.

18. The system of claim 17 wherein the means for indicating to the subscriber that the second call leg is available is operative before the means for transmitting the message to the calling party associated with the second call leg.

19. The system of claim 18 wherein the means for determining whether the subscriber desires to place the second call leg on hold comprises:
means for receiving an indication that the subscriber does not desire that the second call leg be placed on hold and therefore preventing the transmission of the message to a calling party associated with the second call leg offering to place the second call leg on hold.

20. The system of claim 18 wherein the means for determining whether the subscriber desires to place the second call leg on hold comprises:
means for receiving a message selection indication from the subscriber, thereby receiving an indication that the subscriber does desire that the second call leg be placed on hold;
wherein the means for transmitting the message to the calling party associated with the second call leg comprises:
means for transmitting a customized message to the calling party based on the received message selection indication.

21. The system of claim 18 wherein the means for determining whether the subscriber desires to place the second call leg on hold comprises:
means for receiving a message selection indication from the subscriber, thereby receiving an indication that the subscriber does desire that the second call leg be placed on hold;
means for determining an identity of the calling party;
wherein the means for transmitting the message to the calling party associated with the second call leg comprises:
means for transmitting a customized message to the calling party based on the received message selection indication and the determined identity of the calling party.

22. The system of claim 17 wherein the means for determining whether the subscriber desires to place the second call leg on hold comprises:
means for determining an identity of the calling party;
means for transmitting the determined identity of the calling party to the subscriber;
means for receiving a message selection indication from the subscriber, thereby receiving an indication that the subscriber does desire that the second call leg be placed on hold;
wherein the means for transmitting the message to the calling party associated with the second call leg comprises:
means for transmitting a customized message to the calling party based on the received message selection indication and the determined identity of the calling party.

23. The system of claim 17 wherein the means for determining whether the subscriber desires to place the second call leg on hold comprises:
means for receiving information from a subscriber profile of the subscriber indicating that the subscriber desires to place on hold all second calls received while the subscriber is participating in any other call.

24. The system of claim 18 wherein transmitting a customized message to the calling party based on the received message selection indication and the determined identity of the calling party comprises:
means for receiving a list of one or more potential callers, each listed potential caller being associated with at least one predefined message, the at least one predefined message being associated with a particular message selection indication;
means for determining that the determined identity of the calling party matches an identity of one of the listed potential callers; and,
means for transmitting a selected one of the at least one predefined messages associated with the matching listed potential caller, the selected one of the at least one predefined messages being associated with the received message selection indication from the subscriber.

25. The system of claim 18 wherein the means for transmitting a customized message to the calling party based on the received message selection indication and the determined identity of the calling party comprises:
means for receiving a list of one or more predefined default messages, the one or more predefined default messages being associated with a particular message selection indication;
means for determining that the determined identity of the calling party does not match an identity of one of the listed potential callers; and
means for transmitting a selected one of the at least one predefined default messages, the selected one of the at least one predefined default messages being associated with the received message selection indication from the subscriber.

26. The system of claim 16 further comprising:
means for determining that the participation of the subscriber in the first call has ended; and,
means for connecting the second call leg to user equipment of the subscriber.

27. A system for processing a second call leg directed to a subscriber that is participating in a first call, the system comprising:
a profile interpreter operative to receive a subscriber profile, determine if the subscriber subscribes to a call answering and holding feature, determine settings of call answering and holding feature configuration parameters, and provide access to one or more messages stored in the subscriber profile;
a subscriber interface operative to transmit information regarding the second call leg to the subscriber according to the configuration parameter setting, and to receive and interpret indications from the subscriber regarding call treatment directions;
a second caller interface operative to signal a second caller associated with the second call leg according to the configuration parameters and/or the call treatment indications and to receive calling party call treatment indications from the second caller; and,
a hold manager operative to place the second call leg on hold according to the configuration parameters, the subscriber call treatment directions, and/or the calling party call treatment indications.

28. The system of claim 27 wherein the subscriber interface is operative to transmit calling line identification information to the subscriber regarding second call leg.

29. The system of claim 27 wherein the subscriber interface is operative to receive a message selection indication from the subscriber regarding a message to be transmitted to the second caller.

30. The system of claim 27 wherein the second caller interface is operative to transmit a message to the second caller based on an indication received from the subscriber and calling line identification information regarding the second call leg.

31. The system of claim 30 wherein the profile interface and the second caller interface cooperate to compare the calling line identification information to information included in a predefined list of potential callers and to select the transmitted message based on whether or not an entry in the list of potential callers includes information matching the calling line identification information.
